(19) United States
(12) Patent Application Publication
(10) Pub. No.: US 2026/0241380 A1
(43) Pub. Date: Aug. 20, 2026

(54) DENSITY GRADIENT FORMATION WITH SAMPLE PARTICLES

(71) Applicant: Beckman Coulter, Inc., Brea, CA (US)

(72) Inventors: Larry Wayne McIntyre, Carmel, IN (US); Ross VerHeul, Indianapolis, IN (US)

(73) Assignee: Beckman Coulter, Inc., Brea, CA (US)

(21) Appl. No.: 19/157,304

(22) PCT Filed: Feb. 13, 2024
(86) PCT No.: PCT/US2024/015626

§ 371 Date: Aug. 15, 2025

Related U.S. Application Data
(60) Provisional application No. 63/485,136, filed on Feb. 15, 2023.

(51) Int. Cl. B01L 3/02

(52) U.S. Cl. CPC B01L 3/0293; B01L 2200/026; B01L 2200/0647; B01L 2300/0832; B01L 2400/0487

(57) ABSTRACT

A system for dispensing a density gradient in a container is described. The system pumps a volume of sample particles and a density modifier into a mixing chamber in fluid communication with a proximal end of a probe. The mixing chamber mixes the sample particles and the density modifier together to at least partially form the density gradient. The system dispenses the density gradient through a distal end of the probe into the container. The density gradient varies in density between first and second ends, and at least a portion of the density gradient between the first and second ends includes a dispensed volume of the sample particles.

This application is being filed on Feb. 13, 2024, as a PCT International application and claims the benefit of and priority to U.S. Provisional Patent Application No. 63/485,136 filed on Feb. 15, 2023, the disclosure of which is hereby incorporated by reference in its entirety.

### BACKGROUND

Particles including viral vectors such as adenoviruses and adeno-associated viruses (AAVs), extracellular vesicles such as exosomes, and nucleic acids such as plasmid DNA can have a variety of cellular functions, structures, and mechanisms of action. For example, AAVs can have different loadings, which cause AAVs to differ not only in molecular weight, but also in density. In some instances, these types of particles can be separated using a density gradient.

Typically, in order to separate particles using a density gradient, a sample of particles is loaded into a container with a density modifying material forming a homogenous solution having a uniform density. Thereafter, centrifugation is performed on the container to form a density gradient. Eventually, the particles move through the density gradient until the particles reach a density that is equal to their own. The time typically required to form the density gradient by centrifugation, in addition to the time needed for the particles to move through the density gradient to reach a position that matches their density, can take many hours to complete.

### SUMMARY

In general terms, the present disclosure relates to separating particles by using a density gradient. In one possible configuration, the density gradient is formed without centrifugation by automatically dispensing the density gradient with a dispensed volume of sample particles integrated therein. In another possible configuration, the dispensed volume of sample particles is integrated within a range of the density gradient. Various aspects are described in this disclosure, which include, but are not limited to, the following aspects.

One aspect relates to a system for dispensing a density gradient in a container, the system comprising: a processing circuitry having a memory for storing instructions which, when executed by the processing circuitry, cause the processing circuitry to: pump sample particles and a density modifier into a mixing chamber in fluid communication with a proximal end of a probe, the mixing chamber mixing the sample particles and the density modifier together; and dispense the density gradient through a distal end of the probe into the container, the density gradient varying in density between first and second ends, at least a portion of the density gradient between the first and second ends includes a dispensed volume of the sample particles.

Another aspect relates to a method of dispensing a density gradient in a container, the method comprising: pumping sample particles and a density modifier into a mixing chamber in fluid communication with a proximal end of a probe, the mixing chamber mixing the sample particles and the density modifier together; and dispensing the density gradient through a distal end of the probe into the container, the density gradient varying in density between first and second ends, at least a portion of the density gradient between the first and second ends includes a dispensed volume of the sample particles.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### DESCRIPTION OF THE FIGURES

The following drawing figures, which form a part of this application, are illustrative of the described technology and are not meant to limit the scope of the disclosure in any manner.

FIG. 1 schematically illustrates an example of a system for generating density gradients for centrifugation.

FIG. 2 illustrates an example of a mixer housed inside a manifold and mixing chamber of the system of FIG. 1.

FIG. 3 is an isometric view of a probe having a distal end inserted into a container, and a proximal end connected to the manifold and mixing chamber of the system of FIG. 1.

FIG. 4 illustrates an example of the proximal end of the probe connected to the manifold and mixing chamber of the system of FIG. 1.

FIG. 5 schematically illustrates an example of a method of generating a density gradient for separating particles that can be performed by the system of FIG. 1.

FIG. 6 graphically illustrates an example of dispensed volumes for each component along a radial length of a density gradient dispensed by the system of FIG. 1 in accordance with the operations of the method of FIG. 5.

FIG. 7 schematically illustrates another example of a method of generating a density gradient for separating particles that can be performed by the system of FIG. 1.

FIG. 8 graphically illustrates another example of dispensed volumes for each component along a radial length of a density gradient dispensed by the system of FIG. 1 in accordance with the operations of the method of FIG. 7.

FIG. 9 schematically illustrates an example of computing component hardware of the system of FIG. 1.

### DETAILED DESCRIPTION

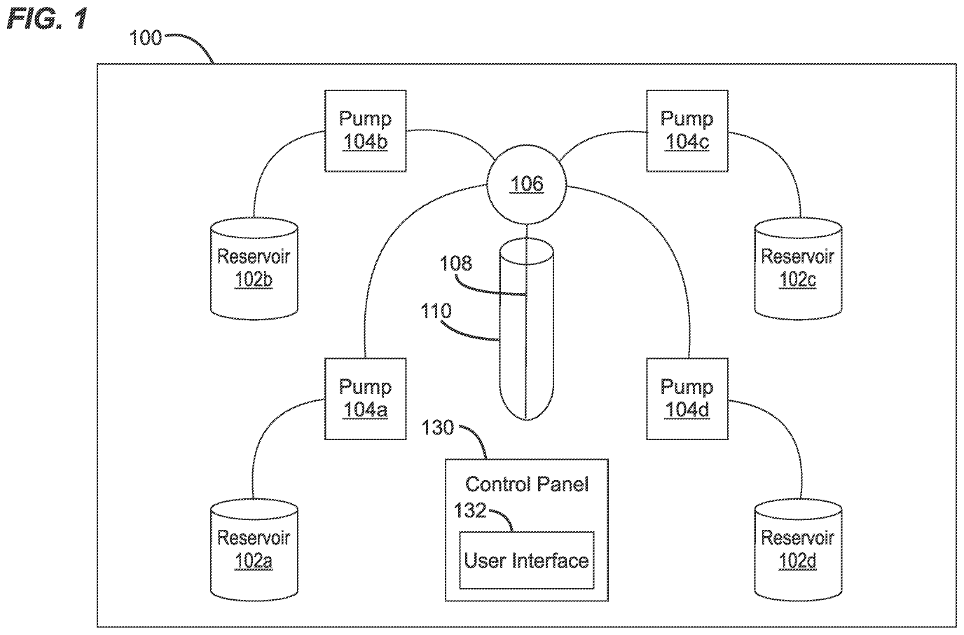

FIG. 1 schematically illustrates an example of a system 100 that can generate density gradients for centrifugation. The system 100 is computer controlled to precisely dispense a gradient of any type, slope, or shape inside a container 110. For example, the system 100 can generate linear density gradients, which have densities that gradually increase from top to bottom, and step density gradients, which have at least two discrete steps of different densities.

In some examples, the system 100 includes features similar to the features in the systems described in U.S. Provisional Patent Application No. 63/369,306, titled AUTOMATIC DISPENSE OF DENSITY GRADIENTS, filed Jul. 25, 2022, in U.S. Provisional Patent Application No. 63/369,299, titled NON-DESTRUCTIVE MEASUREMENT OF DENSITY GRADIENTS, filed on Jul. 25, 2022, and in U.S. Provisional Patent Application No. 63/369,315, titled REPLICATION OF DENSITY GRADIENTS, filed on Jul. 25, 2022, the disclosures of which are hereby incorporated by reference in their entireties.

The system 100 includes reservoirs 102 that each hold a separate component for generating a density gradient inside the container 110. Each reservoir 102 is connected to a pump 104 for pumping the component held in the reservoir 102 into a manifold and mixing chamber 106. The pumps 104 are programmed to pump the components from the reservoirs 102 at predefined volumes and speeds for mixing inside the manifold and mixing chamber 106.

In the example shown in FIG. 1, the system 100 includes four reservoirs such as a first reservoir 102a connected to a first pump 104a for pumping a first component into the manifold and mixing chamber 106, a second reservoir 102b connected to a second pump 104b for pumping a second component into the manifold and mixing chamber 106, a third reservoir 102c connected to a third pump 104c for pumping a third component into the manifold and mixing chamber 106, and a fourth reservoir 102d connected to a fourth pump 104d for pumping a fourth component into the manifold and mixing chamber 106. The system 100 can include more than four reservoirs for holding more than four separate components for generating a density gradient, or can include fewer than four reservoirs for holding fewer than four separate components for generating a density gradient in the container 110.

The components held in the reservoirs 102 are liquids that are pumped into the manifold and mixing chamber 106 for dispensing a stream of fluid into the container 110. As an illustrative example, the first reservoir 102a can hold deionized (DI) water, the second reservoir 102b can hold a density modifier, the third reservoir 102c can hold a buffer solution, and the fourth reservoir 102d can hold sample particles. As an illustrative example, the sample particles can include viral vectors such as lentiviruses, adenoviruses, and adeno-associated viruses (AAVs), lipid nanoparticles carrying mRNA, extracellular vesicles such as exosomes, nucleic acids such as plasmid DNA, and other types of biological or synthetic nanoparticles.

All four components held in the reservoirs 102a-102d can be introduced into a single stream that goes through the manifold and mixing chamber 106. For example, the DI water can be pumped into the manifold and mixing chamber 106 from the first reservoir 102a by the first pump 104a, the density modifier can be pumped into the manifold and mixing chamber 106 from the second reservoir 102b by the second pump 104b, the buffer solution can be pumped into the manifold and mixing chamber 106 from the third reservoir 102c by the third pump 104c, and the sample particles can be pumped into the manifold and mixing chamber 106 from the fourth reservoir 102d by the fourth pump 104d. Thus, various combinations of the contents held in the reservoirs 102a-102d can be pumped into the manifold and mixing chamber 106.

In some examples, the pumps 104a-104d include peristaltic pumps for providing a smooth pumping flow. In some further examples, the pumps 104a-104d include syringe pumps, which can be used when higher precision pumping is desirable.

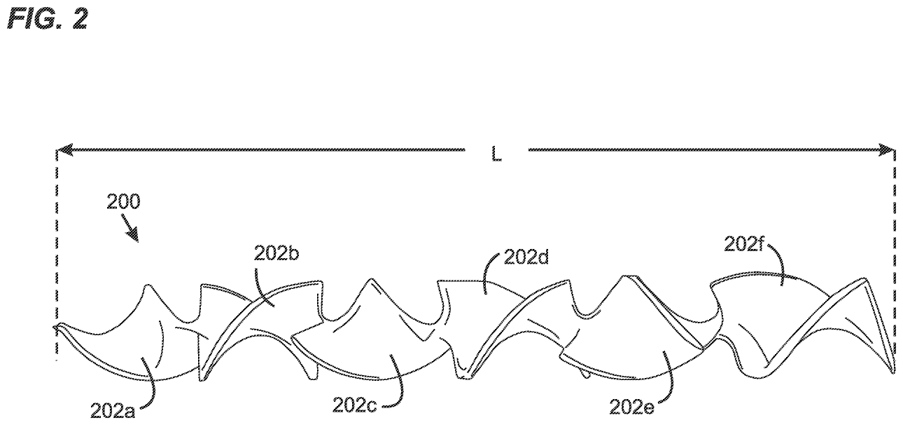

FIG. 2 illustrates an example of a mixer 200 housed inside the manifold and mixing chamber 106 of the system 100. Referring now to FIGS. 1 and 2, various combinations of the DI water, density modifier, buffer solution, and sample particles are introduced into a single stream that goes through the manifold and mixing chamber 106. Inside the manifold and mixing chamber 106, the mixer 200 includes mixing elements 202a-202f that mix the components together as they pass through the mixing elements. The mixer 200 mixes the components together to generate a homogenous stream of fluid for a probe 108 to dispense a density gradient having a spatial variation in density over a radial length of the container 110 based on the relative concentrations of the components mixed by the mixer 200.

In some examples, the mixer 200 is a static mixer and the mixing elements 202a-202f include alternating helical elements. In alternative examples, the manifold and mixing chamber 106 can include alternative types of mixers and mixing elements, including non-static mixers.

In the example provided in FIG. 2, each helical element is set 90° to an adjacent helical element to provide thorough blending of the components over a length L of the mixer 200 inside the manifold and mixing chamber 106. The mixing elements 202a-202f mix the components together to eliminate pockets of low and/or high-density material. The mixing elements 202a-202f slice and rotate the components multiple times together to produce a substantially homogenous stream for the probe 108 to dispense the density gradient into the container 110. As an illustrative example, the mixer 200 can include 12 mixing elements having an outside diameter OD of about 2.3 mm to about 2.4 mm, a total length L of about 27 mm to about 29 mm, and an individual missing element length to diameter ratio of about 1.

Flowrate and mixing chamber parameters, such as the outside diameter OD, the total length L, or the number of mixing elements on the mixer 200, are selected to avoid shear damage to the sample particles. In some examples, different mixers can be used interchangeably within the manifold and mixing chamber 106 based on the type of sample particles mixed by the mixer 200. For example, different mixers having different sizes and/or designs and/or materials can be interchangeably used in the manifold and mixing chamber 106 to maximize mixing while minimizing shear/sample damage for sensitive sample particles such as lentiviruses.

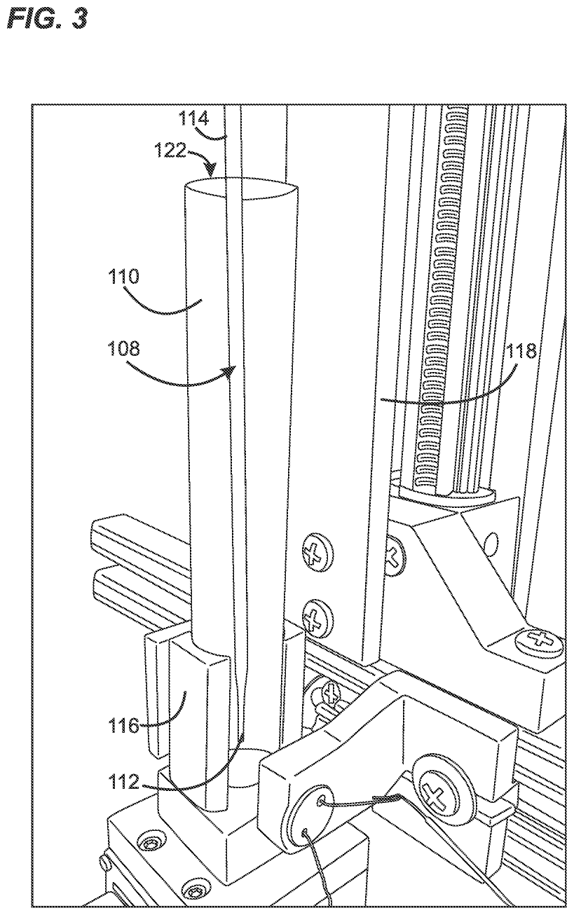

FIG. 3 is an isometric view of the probe 108 having a distal end 112 inserted into the container 110, and a proximal end 114 that is in fluid communication with the manifold and mixing chamber 106. In some examples, the proximal end 114 of the probe 108 is connected directly to the manifold and mixing chamber 106. Alternatively, the proximal end 114 of the probe 108 can be indirectly connected to the manifold and mixing chamber 106 via tubing.

As is shown in FIG. 3, the distal end 112 is positioned toward a bottom of an interior volume 122 of the container 110 such that the probe 108 is ready for dispensing a density gradient inside the interior volume of the container. In examples where the system 100 dispenses the density gradient using an underlay process, the probe 108 remains fixed in the same position while the density of the homogenous stream dispensed through the probe 108 steadily increases. Alternatively, in examples where the system 100 dispenses the density gradient using an overlay process, the probe 108 can move upwards while the density of the homogenous stream dispensed through the probe 108 steadily decreases.

As shown in FIG. 3, the container 110 is fixedly positioned by a holder 116 relative to the probe 108 during dispensing of the density gradient. In the example of FIG. 3, the holder 116 includes a clamp for securely fixing the container 110 to a frame 118 of the system 100.

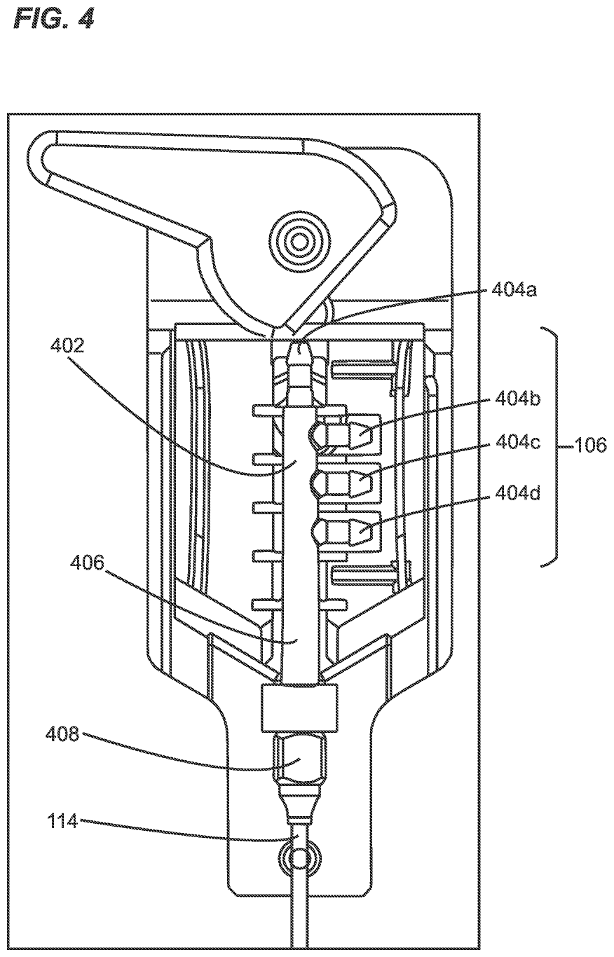

FIG. 4 illustrates an example of the proximal end 114 of the probe 108 connected to the manifold and mixing chamber 106. The manifold and mixing chamber 106 includes a manifold portion 402 having inputs 404a-404b that each receive a component pumped from a reservoir 102a-102d by a pump 104a-104d, respectively. The manifold and mixing chamber 106 further includes a mixing portion 406 housing the mixer 200 for mixing the components pumped from the reservoirs together before they reach the proximal end 114 of the probe 108.

The proximal end 114 of the probe 108 is fixed by a set screw 408 that can be tightened or loosened around the proximal end 114 of the probe 108. The manifold and mixing chamber 106 is attached to a motor driven mechanism that precisely moves the probe 108 up and down to a desired position inside the container 110. In some examples, the probe 108 can be manually lowered into a desired position inside the container 110.

In some examples, the probe 108 includes a coating of non-stick material. In some examples, the coating includes Teflon® and/or similar types of materials. In some examples, the coating is hydrophobic and/or non-wettable. The coating included on the probe 108 prevents the density gradient dispensed in the container 110 from sticking to or building-up on the probe 108. This allows the probe 108 to be removed from the container 110 without unintentionally mixing the portions of the density gradient. Also, the coating can prevent adsorption on the probe 108 of the sample particles and other components dispensed through the probe 108.

Additionally, the manifold and mixing chamber 106 and the probe 108 can be sterilized after each use of the system 100. Also, the manifold and mixing chamber 106 and the probe 108 are free of endotoxins to protect the integrity of the sample particles and all components dispensed through the manifold and mixing chamber 106 and the probe 108.

Referring to FIG. 1, the system 100 can include a control panel 130 for receiving inputs from a user to generate a desired density gradient. In some examples, the control panel 130 includes a user interface 132 such as a touchscreen display that can be used by the user to create the desired density gradient, make measurements thereof, and store a profile of the density gradient. In further examples, the user interface 132 can include additional input devices such as one or more physical buttons that can be selected to control operation of the system 100.

Separating sample particles can be performed by equilibrium-zonal centrifugation, which typically includes layering a sample of particles on top of a density gradient, and then using centrifugal forces to cause the particles to move at different rates depending on their mass. As the particles move down through the density gradient, zones containing particles of similar size form as the faster sedimenting particles move ahead of the slower ones. The zone where the sample particles is layered limits the volume of the sample that can be accommodated by the density gradient. Additionally, the centrifugation time for such techniques is commonly many hours in length, due to the time required for the particles of interest to settle in bands of the density gradient, and the additional time to form the density gradient.

Alternative approaches for separating sample particles can include isopycnic density gradient ultracentrifugation (DGUC), which typically includes combining sample particles with a density-forming material such as cesium chloride (CsCl), potassium bromide, iodixanol, Nycodenz®, or the like to create a homogenous solution of a defined density.

The homogenous solution is then loaded into a container for centrifugation where centrifugal forces cause a density gradient to form. After the density gradient is formed, the sample particles in the sample migrate to positions along the density gradient where the buoyant density of the particles matches the density of the surrounding medium such that the sample particles reach a stable equilibrium. As used herein, stable equilibrium means that the sample particles have sufficiently separated to the point that they can be isolated for extraction, even though the sample particles may not come fully to rest.

The time to form the density gradient is largely dependent on the g-force applied during centrifugation, which becomes a key limiting factor for large volume workflows as g-forces are reduced with increasing volumes. For example, increasing the volume of the density gradient for large-scale workflows can lower throughput because more time is needed to form the density gradient due to lower centrifugation speeds.

Additional factors may also contribute to decreased throughput when separating sample particles using DGUC techniques. For example, temperature can impact the time needed to form the density gradient because using a lower temperature to protect sample particle integrity may add hours to form the density gradient because the diffusion rate is slowed. Also, the type of density modifier that is used, especially the molecular weight and/or diffusion rate and viscosity of the density modifier, can impact the time needed to form the density gradient.

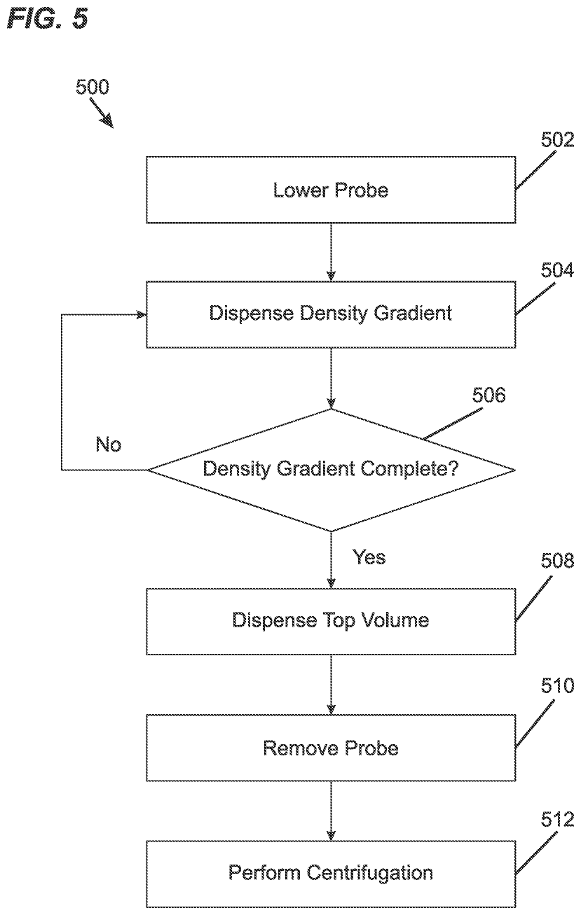

FIG. 5 schematically illustrates an example of a method 500 of generating a density gradient for separating sample particles. The system 100 can perform the method 500 to significantly decrease centrifugation time for reaching equilibrium and separating the particles with high resolution. The method 500 is advantageous for workflows that have large volumes of particles. The method 500 is also advantageous for small scale workflows that are performed for separating particles that are unstable during high g-forces because centrifugation is performed at lower speeds without significantly increasing the time needed to reach stable equilibrium.

As shown in FIG. 5, the method 500 includes an operation 502 of lowering the distal end 112 of the probe 108 close to the bottom of the interior volume 122 of the container 110. An example of this arrangement is shown in FIGS. 1 and 3.

The method 500 includes an operation 504 of dispensing the density gradient into the container 110. The density gradient is dispensed as a homogenous mixture of the density modifier pumped from the second reservoir 102b, the buffer solution pumped from the third reservoir 102c, and the sample particles pumped from the fourth reservoir 102d such that the sample particles are dispensed directly into the density gradient. This is different from equilibrium-zonal centrifugation and isopycnic DGUC, which are described above.

In some examples, operation 504 includes performing an underlay process in which the distal end 112 of the probe 108 remains positioned close to the bottom of the interior volume 122 of the container 110 while the density of the homogenous stream dispensed through the probe 108 steadily increases. Alternatively, operation 504 can include performing an overlay process in which the distal end 112 of the probe 108 moves up the container 110 while the density of the homogenous stream dispensed through the probe 108 steadily decreases.

In some examples, the density gradient dispensed in operation 504 is a continuous gradient that gradually decreases in density moving along the radial length of the container 110. In such instances, the continuous gradient can be either linear or logarithmic. In alternative examples, the density gradient dispensed in operation 504 is a step gradient that has defined interfaces between different layers having different densities.

Each position along the radial length of the density gradient has a density based on a relative concentration of the components pumped from the reservoirs 102. For example, increasing an amount of the density modifier mixed by the manifold and mixing chamber 106 increases the density of a particular portion of the density gradient, whereas decreasing the amount of the density modifier mixed by the manifold and mixing chamber 106 decreases the density of a particular portion of the density gradient.

Next, the method 500 includes an operation 506 of determining whether the density gradient is complete. When the density gradient is not complete (i.e., “No” in operation 506), the method 500 continues to dispense the density gradient in operation 504. When the density gradient is complete (i.e., “Yes” in operation 506), the method 500 can, in at least some examples, proceed to an operation 508 of dispensing a volume on top of the density gradient having a density that is lighter than the lightest density of the density gradient.

In some examples, the volume dispensed on top of the density gradient primarily includes DI water. Operation 508 can be performed especially when the container 110 is a sealed tube to eliminate an air pocket inside the sealed tube left by removing the probe 108 because otherwise the air pocket can cause a weakness in the sealed tube especially at high g-forces during centrifugation. Also, by dispensing the top volume which primarily includes DI water, the probe 108 is cleansed and ready for dispensing a second density gradient in another container. In other examples, such as when the container 110 is an open-top tube, operation 508 is optional.

Next, the method 500 includes an operation 510 of removing the probe 108 from the container 110. Operation 510 can include removing the probe 108 slowly to not disturb the density gradient. As discussed above, the probe 108 can include a coating to prevent the density gradient from sticking to the probe 108 during its removal.

Next, the method 500 includes an operation 512 of placing the container 110 inside a centrifuge for centrifugation to cause the sample particles to separate in the density gradient generated by the method 500. In some examples, operation 512 can include a user manually placing the container 110 inside the centrifuge, and having the user operate the centrifuge to perform centrifugation as desired. In further examples, operation 512 is automated. For example, a mechanical actuator such as a robotic arm can be used to automatically place the container 110 inside the centrifuge, and thereafter, the centrifuge automatically performs the centrifugation of the container 110. In some instances, ultracentrifugation is performed to analyze the sample particles as they separate within the density gradient formed by the method 500.

In the method 500, each of the pumps 104a-104d is programmed to control the flow of each liquid component into the manifold and mixing chamber 106 to have a given dispensed volume for generating the density gradient to have a spatial variation in density over a radial length of the container 110. This allows the system 100 to precisely control the concentration of each liquid component in each portion of the density gradient dispensed by the probe 108.

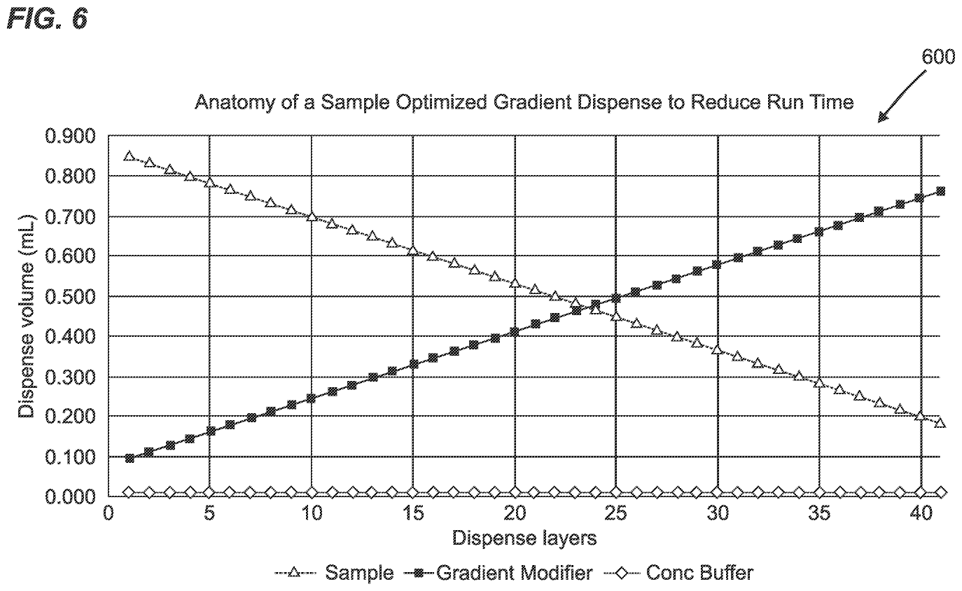

FIG. 6 graphically illustrates an example of dispensed volumes (y-axis) for each component along a radial length (y-axis) of a density gradient 600 dispensed by the system 100 in accordance with the operations of the method 500. In this example, the density gradient 600 is a continuous gradient. Each portion along the radial length of the density gradient 600 includes a combination of the density modifier pumped from the second reservoir 102b, the buffer solution pumped from the third reservoir 102c, and the sample particles pumped from the fourth reservoir 102d such that the sample particles are dispensed directly into the density gradient 600. Thus, in this example, the density gradient 600 includes dispensed volumes of the sample particles along an entirety of the radial length of the density gradient 600.

As shown in FIG. 6, a top portion of the density gradient 600 (i.e., left side of FIG. 6) includes a lowest dispense volume of the density modifier such that it has the lowest density in the density gradient 600, and a bottom portion of the density gradient 600 (i.e., right side of FIG. 6) includes a highest dispense volume of the density modifier such that it has the highest density in the density gradient 600 such that the density of the density gradient 600 gradually increases. In some examples, the density gradient 600 has a density range between about 1.0 g/mL and 1.8 g/mL. This range can accommodate viral vectors that may range in density between about 1.3 g/mL and 1.5 g/mL, such as for adenoviruses and adeno-associated viruses (AAVs).

In the illustrative example shown in FIG. 6, the density gradient 600 has a total volume of about 39 mL which includes about 21 mL of the sample particles. An even larger volume of the sample particles can be introduced into the density gradient 600 by reducing a slope of the dispense volume of the density modifier component, or by utilizing a higher concentration of stock solution of density modifier.

Since the density gradient is formed during operation 504 in the method 500, the centrifugation time that is typically needed to form the density gradient is significantly reduced or even eliminated, which reduces the overall time for separating the sample particles. For example, when starting with a homogeneous solution of density gradient material mixed with a sample particles (e.g., isopycnic DGUC), two equilibria are reached and at different times: a first equilibrium is reached when the density gradient stabilizes, followed by a second equilibrium when the movement of the sample particles stabilize along the radial length of the density gradient. The sample equilibrium is not fully reached when the density gradient is initially formed. Instead, it may take several more hours to reach the sample equilibrium.

The method 500 eliminates the first step in this two-step process because centrifugation is only performed for the second step (e.g., sample equilibrium) because centrifugation for forming the density gradient is significantly reduced or even eliminated. The method 500 allows the sample particles to move to their respective equilibrium positions without having to first form the density gradient. An isopycnic DGUC process for separating sample particles that takes about 20 hours, can be reduced to less than 5 hours by the method 500.

Dispensing the particles from the sample within the continuous density gradient is not readily possible with traditional density gradient forming techniques, which are largely manual processes. This is because controlling the sample introduction and the density gradient formation by hand with a requisite level of precision would be impossible.

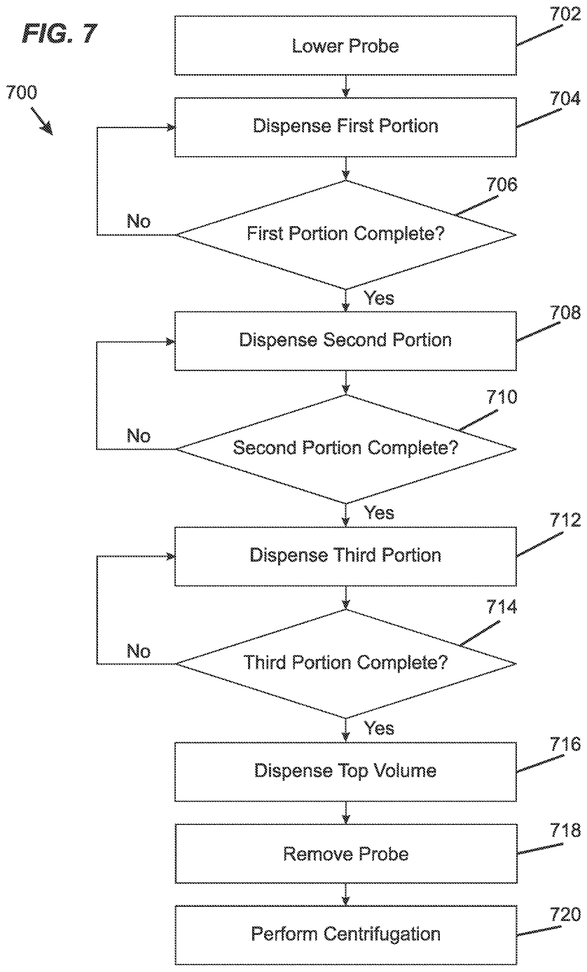

FIG. 7 schematically illustrates another example of a method 700 of generating a density gradient for separating sample particles. The method 700 can be performed by the system 100 to decrease the centrifugation time even further for separating the particles. The method 700 is especially advantageous for early development, analytical, and other low-volume workflows where rapid turnaround time is critical for a variety of samples.

The method 700 includes an operation 702 of lowering the distal end 112 of the probe 108 close to the bottom of the interior volume 122 of the container 110. Operation 702 is substantially similar to operation 502 in the method 500 described above.

Next, the method 700 includes an operation 704 of dispensing a first portion of the density gradient into the container 110. In operation 704, the first portion includes a homogenous mixture of the DI water pumped from the first reservoir 102a, the density modifier pumped from the second reservoir 102b, and the buffer solution pumped from the third reservoir 102c. The sample particles are not dispensed into the first portion of the density gradient.

In some examples, operation 704 includes performing an underlay process in which the distal end 112 of the probe 108 remains positioned close to the bottom of the interior volume 122 of the container 110 while the density of the homogenous stream dispensed through the probe 108 steadily increases. Alternatively, operation 704 can include performing an overlay process in which the distal end 112 of the probe 108 moves up the container 110 while the density of the homogenous stream dispensed through the probe 108 steadily decreases.

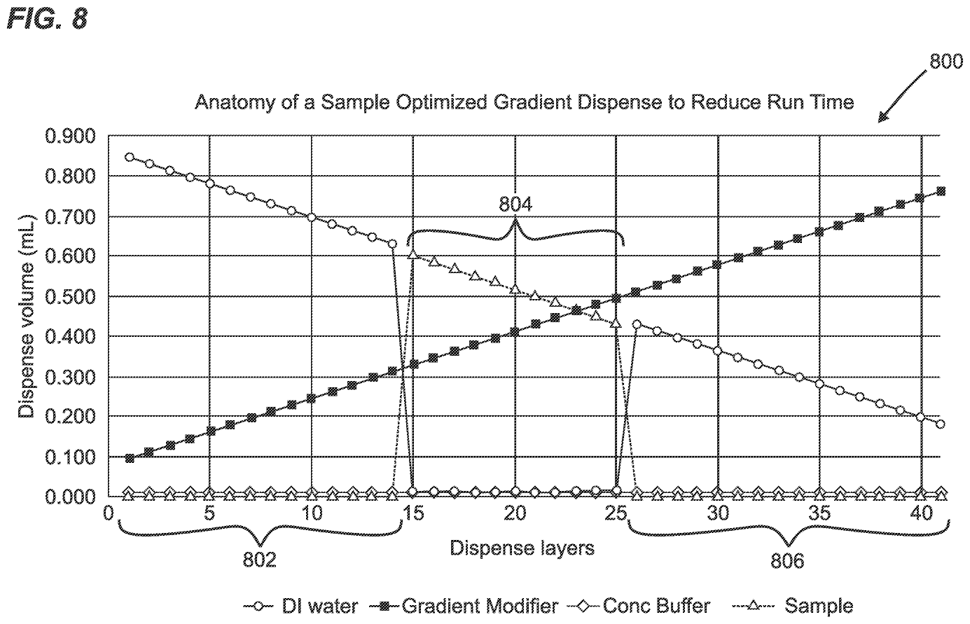

FIG. 8 graphically illustrates example dispensed volumes of each component in each portion of a density gradient 800 dispensed by the system 100 in accordance with the operations of the method 700. As shown in the example provided in FIG. 8, a first portion 802 of the density gradient 800 includes a combination of DI water, density modifier, and buffer solution. The first portion 802 does not include the sample particles which have a dispensed volume of 0. In the first portion 802, the dispensed volume of the DI water gradually decreases while the dispensed volume of the density modifier steadily increases, which causes the density of the first portion 802 of the density gradient 800 to gradually increase. This is indicative of an underlay process.

In the example provided in FIG. 8, the density gradient 800 is a continuous gradient that gradually decreases in density moving along the radial length of the container 110. In alternative examples, the density gradient 800 dispensed by the method 700 can be a step gradient that has sharp interfaces between different portions having different densities.

Referring to FIG. 7, the method 700 next includes an operation 706 of determining whether the first portion of the density gradient is complete. When the first portion of the density gradient is not complete (i.e., “No” in operation 706), the method 700 continues to dispense the first portion of the density gradient in operation 704. When the first portion of the density gradient is complete (i.e., “Yes” in operation 706), the method 700 proceeds to an operation 708 of dispensing a second portion of the density gradient into the container 110.

In operation 708, the second portion includes a homogenous mixture of the sample particles pumped from the fourth reservoir 102d, the density modifier pumped from the second reservoir 102b, and the buffer solution pumped from the third reservoir 102c. In some examples, operation 708 includes performing an underlay process in which the distal end 112 of the probe 108 remains positioned close to the bottom of the interior volume 122 of the container 110 while the density of the homogenous stream dispensed through the probe 108 steadily increases. Alternatively, operation 708 can include performing an overlay process in which the distal end 112 of the probe 108 moves up the container 110 while the density of the homogenous stream dispensed through the probe 108 steadily decreases.

As shown in the example provided in FIG. 8, a second portion 804 of the density gradient 800 includes a combination of sample particles, density modifier, and buffer solution. In this example, the second portion 804 does not include dispensed volumes of DI water, which are 0. Instead, the dispensed volumes of the sample particles replace the dispensed volumes of the DI water in the second portion 804. In alternative examples, the second portion 804 can include dispensed volumes DI water, in which case, the sample particles in the second portion 804 would have lower dispensed volumes than the dispensed volumes illustrated in the example of FIG. 8 in order to accommodate the gradually increasing density of the second portion 804.

In the second portion 804, the dispensed volume of the sample particles gradually decreases while the dispensed volume of the density modifier steadily increases, causing the density of the second portion 804 to gradually increase. This is indicative an underlay process. As shown in FIG. 8, the sample particles are dispensed directly into the second portion of the density gradient, which is different from equilibrium-zonal centrifugation and isopycnic DGUC.

Referring to FIG. 7, the method 700 next includes an operation 710 of determining whether the second portion of the density gradient is complete. When the second portion is not complete (i.e., “No” in operation 710), the method 700 continues to dispense the second portion of the density gradient in operation 708. When the second portion of the density gradient is complete (i.e., “Yes” in operation 710), the method 700 proceeds to an operation 712 of dispensing a third portion of the density gradient into the container 110.

In operation 712, the third portion includes a homogenous mixture of the DI water pumped from the first reservoir 102a, the density modifier pumped from the second reservoir 102b, and the buffer solution pumped from the third reservoir 102c. The sample particles are not dispensed into the third portion of the density gradient.

In some examples, operation 712 includes performing an underlay process in which the distal end 112 of the probe 108 remains positioned close to the bottom of the interior volume 122 of the container 110 while the density of the homogenous stream dispensed through the probe 108 steadily increases. Alternatively, operation 712 can include performing an overlay process in which the distal end 112 of the probe 108 moves up the container 110 while the density of the homogenous stream dispensed through the probe 108 steadily decreases.

As shown in FIG. 8, a third portion 806 in the density gradient 800 includes a combination of DI water, density modifier, and buffer solution. The third portion 806 does not include the sample particles which have a dispensed volume of 0. In the third portion 806, the dispensed volume of the DI water gradually decreases while the dispensed volume of the density modifier steadily increases, which causes the density of the third portion 806 of the density gradient 800 to gradually increase. This is indicative of an underlay process

The method 700 includes an operation 714 of determining whether the third portion of the density gradient is complete. When the third portion is not complete (i.e., “No” in operation 714), the method 700 continues to dispense the third portion of the density gradient in operation 712. When the third portion of the density gradient is complete (i.e., “Yes” in operation 714), the method 700 can proceed to an operation 716 of dispensing a top volume, followed by an operation 718 of removing the probe 108 from the container 110, and followed by an operation 720 of placing the container 110 inside a centrifuge for centrifugation to cause the sample particles to separate in the density gradient by the method 700. Operations 716-720 can be substantially similar to operations 508-512 of the method 500, as described above.

As shown in FIG. 8, the density gradient 800 generated by the method 700 includes dispensed volumes of the sample particles within a range of the density gradient 800. For example, the density gradient 800 includes dispensed volumes of the sample particles only in the second portion 804, which is sandwiched between the first and third portions 802, 806, which do not include dispensed volumes of the sample particles. In further examples, the density gradient 800 can include multiple portions that include dispensed volumes of the sample particles. The multiple portions that include dispensed volumes of the sample particles can be discontinuous with respect to one another such that the portions that include dispensed volumes of the sample particles are separated by portions that do not include dispensed volumes of the sample particles.

Dispensing sample particles within discrete locations of a continuous density gradient is not readily possible with traditional density gradient techniques, which are largely manual processes, because controlling the sample particle dispense and the density gradient formation by hand with a requisite level of precision would be impossible. Advantageously, the method 700 allows the density gradient 800 to have an even shorter centrifugation time for separating the sample particles because the sample particles can be dispensed closer to where their expected densities are located along the radial length of the density gradient 800. This reduces the distance that the particles must travel to reach their equilibrium position, and thus further shortens the centrifugation time.

In some examples, the system 100 automatically determines using a predicting model one or more desired parameters of the density gradient based on the type of sample particles that are to be separated such as a relationship between the highest density and the lowest density in the gradient such as a radial length and/or a slope of the dispensed volumes of the components across the radial length, whether the gradient is linear, logarithmic, continuous, or step, and when it is desired to not uniformly distribute the sample particles in the density gradient, the location(s) for dispensing the sample particles in the density gradient as a function of the length of the container 110 or the estimated density of the sample particles.

Also, to maximize efficiency in the centrifuge, the density gradient dispensed in accordance with the operations of the methods 500, 700 can be dispensed to precisely match a known gradient composition that is prescribed, or to match an experimental gradient that was shown to be successful. For example, container size and/or geometry, centrifuge rotor geometry, temperature, centrifuge speed (rpm/rcf), and other parameters can dictate an optimal density gradient profile for separating the sample particles. The predicting model can also consider these parameters when dispensing the density gradient to match an optimal density gradient profile.

The volume of the sample particles that are introduced into the density gradient 800 generated by the method 700 is less than the amount of sample particles that are introduced into the density gradient 600 generated by the method 500. In this example, about 5.7 mL of sample is introduced into the density gradient 800 which has a total volume of 39 mL. Thus, the method 700 can be especially advantageous for early development, analytical, and other low-volume workflows where rapid turnaround time is critical for a variety of samples.

Creating the density gradients 600, 800 by selectively dispensing the sample particles directly into these continuous density gradients can significantly increase a throughput of separating the sample particles by reducing overall centrifugation time. This can maximize the throughput and efficiency in separating large sample volumes. Also, this can minimize the time to efficiently separate relatively small sample volumes.

Additionally, since centrifugation is eliminated, or is otherwise significantly reduced for density gradient formation by the methods 500, 700, these methods can utilize a larger variety of density modifier materials such as sucrose that would otherwise be impractical for use in equilibrium-zonal centrifugation and isopycnic DGUC. For example, the methods 500, 700 can generate continuous density gradients using density modifiers that have lower densities (e.g., sucrose), which would require much longer centrifugation times and/or much larger centrifugal forces in equilibrium-zonal centrifugation and isopycnic DGUC techniques that are impractical.

As another example, the use of iodixanol as a density modifier can sometimes be impractical in traditional particle separation techniques using density gradients. Iodixanol has a relatively high molecular weight and is also viscous, unlike cesium chloride (CsCl). At high speeds, iodixanol forms very steep gradients, which can limit resolution between sample species. At low speeds, density gradients formed by using iodixanol would form very slowly. The methods 500, 700 can overcome these challenges associated with using iodixanol as a density modifier because the slope of the density gradients formed by the methods 500, 700 can be controlled without compromising on centrifugation time since the centrifugation that is typically necessary for forming the density gradients is significantly reduced, or even eliminated.

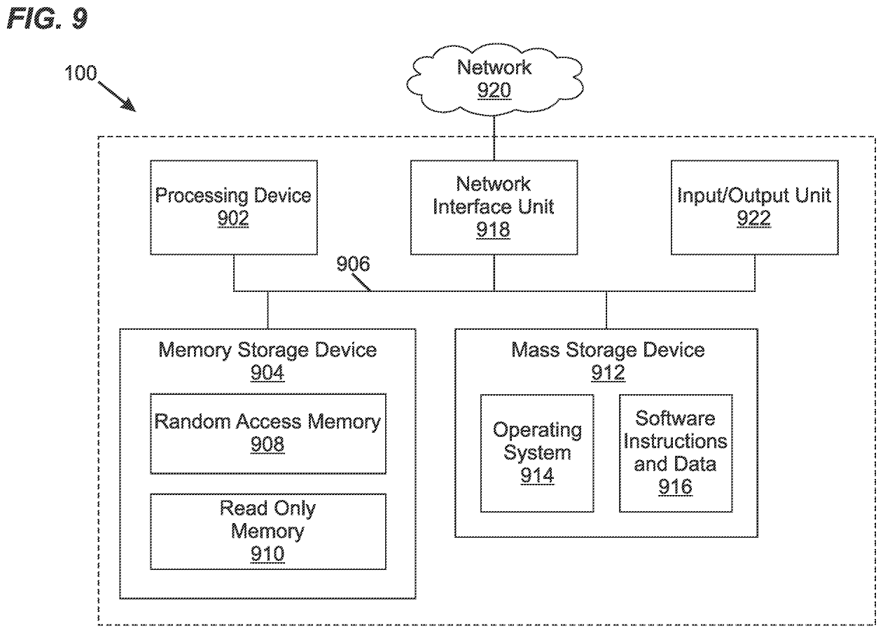

FIG. 9 schematically illustrates an example of computing hardware of the system 100 for implementing aspects of the present disclosure. As shown in FIG. 9, the system 100 includes one or more processing devices 902, a memory storage device 904, and a system bus 906 that couples the memory storage device 904 to the one or more processing devices 902. The one or more processing devices 902 can include central processing units (CPU). In some instances, the one or more processing devices 902 are part of a processing circuitry having a memory for storing instructions which, when executed by the processing circuitry, cause the processing circuitry to perform the various aspects, features, and functionalities described herein.

As shown in FIG. 9, the memory storage device 904 can include a random-access memory (“RAM”) 908 and a read-only memory (“ROM”) 910. Basic input and output logic having basic routines that help to transfer information between elements within the system 100, such as during startup, can be stored in the ROM 910.

The system 100 can also include a mass storage device 912 that can include an operating system 914 and store software instructions and data 916. The mass storage device 912 is connected to the processing device 902 through the system bus 906. The mass storage device 912 and associated computer-readable data storage media provide non-volatile, non-transitory storage for the system 100.

Although the description of computer-readable data storage media contained herein refers to the mass storage device 912, it should be appreciated by those skilled in the art that computer-readable data storage media can be any available non-transitory, physical device or article of manufacture from which the system 100 can read data and/or instructions. The computer-readable storage media can be comprised of entirely non-transitory media. The mass storage device 912 is an example of a computer-readable storage device.

Computer-readable data storage media include volatile and non-volatile, removable, and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid-state memory technology, or any other medium which can be used to store information, and which can be accessed by the device.

The system 100 can operate in a networked environment using logical connections to the other devices through the network 920. The system 100 connects to the network 920 through a network interface unit 918 connected to the system bus 906. The network interface unit 918 can also connect to additional types of communications networks and devices, including through Bluetooth, Wi-Fi, and cellular telecommunications networks including 4G and 5G networks. The network interface unit 918 can connect the system 100 to additional networks, systems, and devices. The system 100 also includes an input/output unit 922 for receiving and processing inputs and outputs from peripheral devices.

The mass storage device 912 and the RAM 908 can store software instructions and data. The software instructions can include an operating system 914 suitable for controlling the operation of the system 100. The mass storage device 912 and/or the RAM 908 can also store the software instructions and data 916, which when executed by the processing device 902, provide the functionality of the system 100 discussed herein.

The various embodiments described above are provided by way of illustration only and should not be construed to be limiting in any way. Various modifications can be made to the embodiments described above without departing from the true spirit and scope of the disclosure.

What is claimed is:

1. A system for dispensing a density gradient in a container, the system comprising:
a processing circuitry having a memory for storing instructions which, when executed by the processing circuitry, cause the processing circuitry to:
pump sample particles and a density modifier into a mixing chamber in fluid communication with a proximal end of a probe, the mixing chamber mixing the sample particles and the density modifier together; and
dispense the density gradient through a distal end of the probe into the container, the density gradient varying in density between first and second ends, at least a portion of the density gradient between the first and second ends includes a dispensed volume of the sample particles.

2. The system of claim 1, wherein the density gradient is a continuous gradient that increases in density between the first and second ends.

3. The system of claim 1, wherein the density gradient is a step gradient having interfaces of different densities between the first and second ends.

4. The system of claim 1, wherein the instructions, when executed by the processing circuitry, further cause the processing circuitry to:
dispense the density gradient to include dispensed volumes of the sample throughout an entirety of the density gradient.

5. The system of claim 1, wherein the instructions, when executed by the processing circuitry, further cause the processing circuitry to:
dispense the density gradient to include dispensed volumes of the sample particles in a portion of the density gradient sandwiched between portions that do not include dispensed volumes of the sample particles.

6. The system of claim 5, wherein the instructions, when executed by the processing circuitry, further cause the processing circuitry to:
dispense a first portion of the density gradient, the first portion including dispensed volumes of the density modifier without the sample particles;
dispense a second portion of the density gradient, the second portion including dispensed volumes of the density modifier and the sample particles; and
dispense a third portion of the density gradient, the third portion including dispensed volumes of the density modifier without the sample particles.

7. The system of claim 6, wherein the instructions, when executed by the processing circuitry, further cause the processing circuitry to:
dispense the first portion of the density gradient by increasing the dispensed volumes of the density modifier and decreasing dispensed volumes of deionized water causing the density of the first portion to increase along the first portion;
dispense the second portion of the density gradient by increasing the dispensed volumes of the density modifier and decreasing dispensed volumes of the sample particles causing the density of the second portion to increase along the second portion; and
dispense the third portion of the density gradient by increasing the dispensed volumes of the density modifier and decreasing dispensed volumes of the deionized water causing the density of the third portion to increase along the third portion.

8. The system of claim 1, wherein the instructions, when executed by the processing circuitry, further cause the processing circuitry to:
lower the distal end of the probe toward a bottom of the container before dispensing the density gradient; and
remove the probe from the container after dispensing the density gradient.

9. The system of claim 1, wherein the density of the density gradient ranges between 1.0 g/mL and 1.8 g/mL between the first and second ends.

10. A method of dispensing a density gradient in a container, the method comprising:
pumping sample particles and a density modifier into a mixing chamber in fluid communication with a proximal end of a probe, the mixing chamber mixing the sample particles and the density modifier together; and
dispensing the density gradient through a distal end of the probe into the container, the density gradient varying in density between first and second ends, at least a portion of the density gradient between the first and second ends includes a dispensed volume of the sample particles.

11. The method of claim 10, wherein the density gradient is a continuous gradient that increases in density between the first and second ends.

12. The method of claim 10, wherein the density gradient is a step gradient having interfaces of different densities between the first and second ends.

13. The method of claim 10, further comprising:
dispensing the density gradient to include dispensed volumes of the sample particles throughout an entirety of the density gradient.

14. The method of claim 10, further comprising:
dispensing the density gradient to include dispensed volumes of the sample particles in a portion of the density gradient sandwiched between portions that do not include dispensed volumes of the sample particles.

15. The method of claim 14, further comprising:
dispensing a first portion of the density gradient, the first portion including dispensed volumes of the density modifier without the sample particles;
dispensing a second portion of the density gradient, the second portion including dispensed volumes of the density modifier and the sample particles; and
dispensing a third portion of the density gradient, the third portion including dispensed volumes of the density modifier without the sample particles.

16. The method of claim 15, further comprising:
dispensing the first portion of the density gradient by increasing the dispensed volumes of the density modifier and decreasing dispensed volumes of deionized water causing the density of the first portion to increase along the first portion;
dispensing the second portion of the density gradient by increasing the dispensed volumes of the density modifier and decreasing dispensed volumes of the sample particles causing the density of the second portion to increase along the second portion; and
dispensing the third portion of the density gradient by increasing the dispensed volumes of the density modifier and decreasing dispensed volumes of the deionized water causing the density of the third portion to increase along the third portion.

17. The method of claim 10, further comprising:
lowering the distal end of the probe toward a bottom of the container before dispensing the density gradient; and
removing the probe from the container after dispensing the density gradient.

18. The method of claim 10, wherein the density of the density gradient ranges between 1.0 g/mL and 1.8 g/mL between the first and second ends.
